(19) United States
(12) Patent Application Publication
(10) Pub. No.: US 2025/0086377 A1
(43) Pub. Date: Mar. 13, 2025

(54) ELECTRONIC DEVICE AND NON-TRANSITORY COMPUTER-READABLE STORAGE MEDIUM

(71) Applicant: POTIX CORPORATION, Taipei City (TW)

(72) Inventors: Chih-Heng Chen, Taipei City (TW); Jen-Feng Chao, Taipei City (TW); Wenning Hsu, Taipei City (TW); Ming-Shia Yeh, Taipei City (TW)

(73) Assignee: POTIX CORPORATION, Taipei City (TW)

(21) Appl. No.: 18/391,227

(22) Filed: Dec. 20, 2023

(30) Foreign Application Priority Data
Sep. 7, 2023 (TW) 112134156

(51) Int. Cl. G06F 40/157; G06F 18/241; G06F 40/137; G06F 40/18

(52) U.S. Cl. CPC G06F 40/157; G06F 18/241; G06F 40/137; G06F 40/18

(57) ABSTRACT

An electronic device and a non-transitory computer-readable storage medium are provided. The electronic device includes a storage module and a processing module. The processing module loads at least one program instruction to perform the following steps: parsing a plurality of cells in an analysis region of a data sheet to identify each cell as one of at least one formula cell and at least one non-formula cell; classifying, according to a formula expression of at least one formula cell, the at least one formula cell to at least one formula group; selectively establishing a side label category tree, a top label category tree, and a master category tree according to the at least one formula group; establishing a database data model according to the side label category tree, the top label category tree, and the master category tree; and converting each formula expression into a structure reference form.

### CROSS-REFERENCE TO RELATED APPLICATION

This non-provisional application claims priority under 35 U.S.C. § 119(a) to Patent Application No. 112134156 filed in Taiwan, R.O.C. on Sep. 7, 2023, the entire contents of which are hereby incorporated by reference.

### BACKGROUND

### Technical Field

An electronic device and a non-transitory computer-readable storage medium in particular refer to an electronic device and a non-transitory computer-readable storage medium that can establish a database data model.

### Related Art

People have long used spreadsheets to build cross-tabulation reports or fill out forms. People place types and dates in side cells and top cells, and use them as side labels and top labels of the spreadsheet respectively, and then write corresponding values or functions in the cells within intersection range of two labels. In this way, a data sheet can be established that can be directly understood by users. However, when the users perform complex data analysis, the data sheet needs to be established into a data model, so that a computer device can understand the labels and numerical meanings of the data sheet according to the data model. However, converting a user-edited spreadsheet into a data model requires a data engineer to manually transfer the values and labels of the data sheet into the data model, which is unintuitive and difficult for the ordinary users.

### SUMMARY

In view of this, the present invention provides an electronic device and a non-transitory computer-readable storage medium. The electronic device includes a storage module and a processing module. The storage module is configured to store at least one program instruction. The processing module is coupled to the storage module and is configured to load the at least one program instruction to perform the following steps: parsing a plurality of cells in an analysis region of a data sheet to identify each cell as one of at least one formula cell and at least one non-formula cell; classifying, according to a formula expression of the at least one formula cell, the at least one formula cell to at least one formula group; selectively establishing a side label category tree, a top label category tree, and a master category tree according to the at least one formula group; establishing a database data model according to the side label category tree, the top label category tree, and the master category tree; and converting, according to the side label category tree, the top label category tree, and the master category tree, formula expressions into a structure reference form.

In some embodiments, a step of selectively establishing the side label category tree, the top label category tree, and the master category tree according to the at least one formula group further includes: classifying, according to a function of the formula expressions, referenced cells into at least one data group; selectively establishing the side label category tree, the top label category tree, and the master category tree according to the at least one data group, where the at least one data group includes at least one aggregable data group and at least one non-aggregable data group.

In some embodiments, when at least one aggregable data group intersects with another data group, the intersecting data groups are merged into at least one aggregable data group.

In some embodiments, when the function is one of an addition function and a subtraction function, correspondingly referenced cells are classified into the at least one aggregable data group.

In some embodiments, when the function is an aggregate function, correspondingly referenced cells are classified into the at least one aggregable data group.

In some embodiments, when the function is one of a multiplication function and a division function, correspondingly referenced cells are classified into the at least one non-aggregable data group.

In some embodiments, when the function is a non-aggregate function, correspondingly referenced cells are classified into the at least one non-aggregable data group.

In some embodiments, the step of selectively establishing the side label category tree, the top label category tree, and the master category tree according to the formula group further includes: establishing the side label category tree according to at least one side label of the analysis region; establishing the top label category tree according to at least one top label of the analysis region; and merging the side label category tree and the top label category tree into the master category tree.

In some embodiments, the at least one non-aggregable data group includes a single-row non-aggregable data group; and a first data model is established at an intersection of the single-row non-aggregable data group and the top label category tree, and the first data model includes a first category field and a first value field.

In some embodiments, the at least one non-aggregable data group includes a single-column non-aggregable data group; and a second data model is established at an intersection of the single-column non-aggregable data group and the side label category tree, and the second data model includes a second category field and a second value field.

In some embodiments, a third data model is established at an intersection of the at least one aggregable data group and the master category tree, and the third data model includes a third category field and a third value field.

In some embodiments, a step of establishing the database data model according to the side label category tree, the top label category tree, and the master category tree further includes: merging the first data model, the second data model, and the third data model into the database data model.

In some embodiments, a step of classifying, according to the formula expression of the at least one formula cell, the at least one formula cell to the at least one formula group further includes: when the functions of the formula expressions of the formula cells are the same and the cells referenced by the function have a same offset relative to a corresponding formula cell, classifying similar formula cells into a same formula group.

In some embodiments, a step of classifying, according to a formula expression of the at least one formula cell, the at least one formula cell to at least one formula group further includes: defining, when all the formula cells in the formula group are located in a same row, the formula group as a single-row formula group; defining, when all the formula cells in the formula group are located in a same column, the formula group as a single-column formula group; and defining another formula group that does not belong to the single-row formula group nor the single-column formula group as a single-cell formula group.

In some embodiments, the formula group is determined and defined under the single-column formula group: searching for cells referenced by the single-column formula group; searching for a column range of referenced cells; traversing the top label category tree to find column indexes covering the column range; and forming the structure reference form according to the column indexes.

In some embodiments, the formula group is determined and defined under the single-row formula group: searching for cells referenced by the single-row formula group; searching for a row range of referenced cells; traversing the side label category tree to find row indexes covering the row range; and forming the structure reference form according to the row indexes.

In some embodiments, the formula group is determined and defined under the single-cell formula group: searching for cells referenced by the single-cell formula group; searching for a column range and a row range of referenced cells; traversing the side label category tree to find row indexes covering the row range; traversing the top label category tree to find column indexes covering the column range; and forming the structure reference form according to the column indexes and the row indexes.

In some embodiments, a step of classifying, according to a formula expression of the at least one formula cell, the at least one formula cell to at least one formula group further includes: analyzing the function of the formula cells to establish a reference relationship; and retrieving table values of corresponding non-formula cells according to the reference relationship.

In some embodiments, a non-transitory computer-readable storage medium is provided. The non-transitory computer-readable storage medium stores at least one program instruction, where after a computer loads and executes the at least one program instruction, the following steps are performed: parsing a plurality of cells in an analysis region of a data sheet to identify each cell as one of at least one formula cell and at least one non-formula cell; classifying, according to a formula expression of the at least one formula cell, the at least one formula cell to at least one formula group; selectively establishing a side label category tree, a top label category tree, and a master category tree according to the at least one formula group; establishing a database data model according to the side label category tree, the top label category tree, and the master category tree; and converting, according to the side label category tree, the top label category tree, and the master category tree, formula expressions into a structure reference form.

In conclusion, the electronic device and the non-transitory computer-readable storage medium provided in the present invention can automatically convert a data sheet into a database data model for the electronic device to perform subsequent analysis and processing operations. In addition, the electronic device identifies a cell in the data sheet as one of at least one formula cell and at least one non-formula cell, to accurately determine a side label, a top label, and a table value, so that the established database data model can be imported into a corresponding value to a correct field. In addition, a processing module converts each formula expression into a structure reference form, which is easier to understand than an expression recorded in an original data sheet. That is, when the processing module parses a formula expression in the structure reference form, the meaning of the formula expression can be understood from a structure of the formula.

Detailed features and advantages of the present invention are described in detail in the following implementations, and the content of the implementations is sufficient for a person skilled in the art to understand and implement the technical content of the present invention. A person skilled in the art can easily understand the objectives and advantages related to the present invention according to the contents disclosed in this specification, the claims and the drawings.

### BRIEF DESCRIPTION OF THE DRAWINGS

FIG. 1 is a block diagram of an electronic device according to some embodiments of the present invention.

FIG. 2 is a flowchart of a processing module executing a program instruction according to some embodiments of the present invention.

FIG. 3 is a schematic diagram of a data sheet according to some embodiments of the present invention.

FIG. 4 is a schematic diagram of a database data model according to some embodiments of the present invention.

FIG. 5 is a schematic diagram of a side label category tree according to some embodiments of the present invention.

FIG. 6 is a schematic diagram of a top label category tree according to some embodiments of the present invention.

FIG. 7 is a schematic diagram of a master category tree according to some embodiments of the present invention.

FIG. 8 is a schematic diagram of a first data model according to some embodiments of the present invention.

FIG. 9 is a schematic diagram of a third data model according to some embodiments of the present invention.

### DETAILED DESCRIPTION

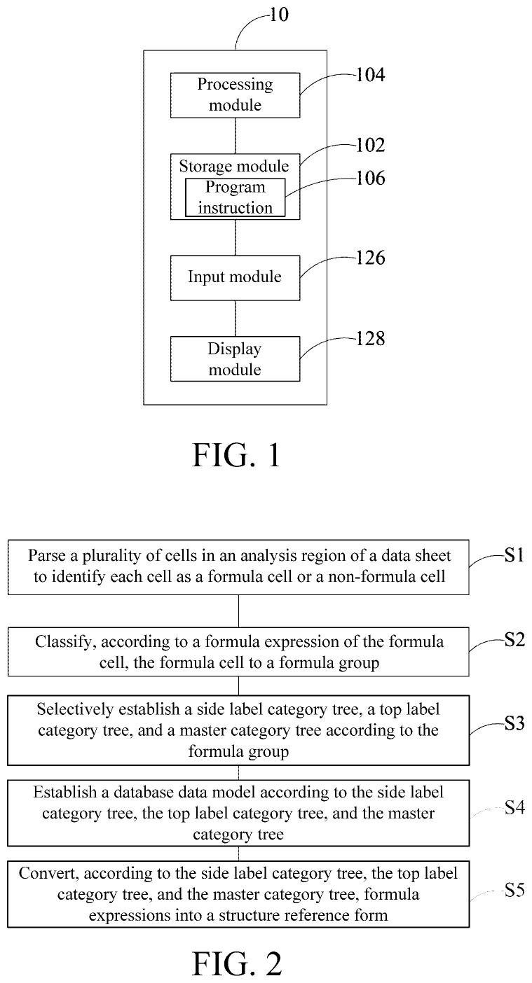

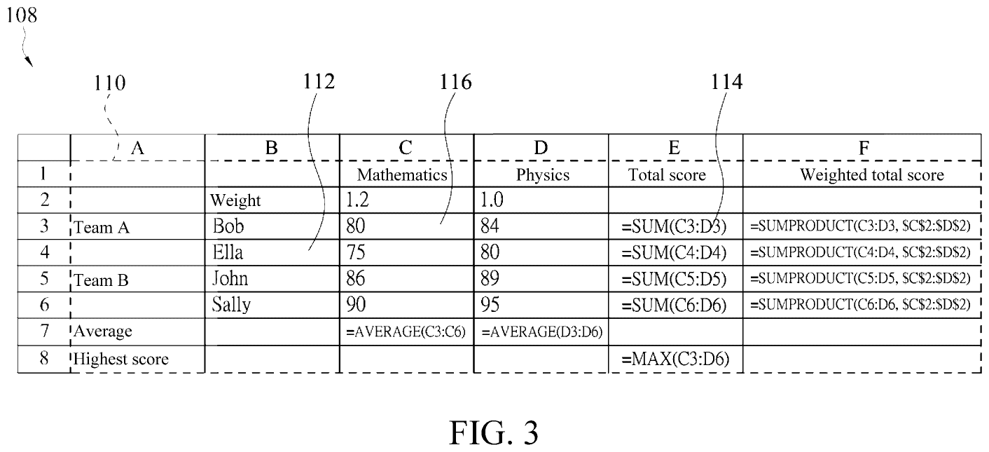

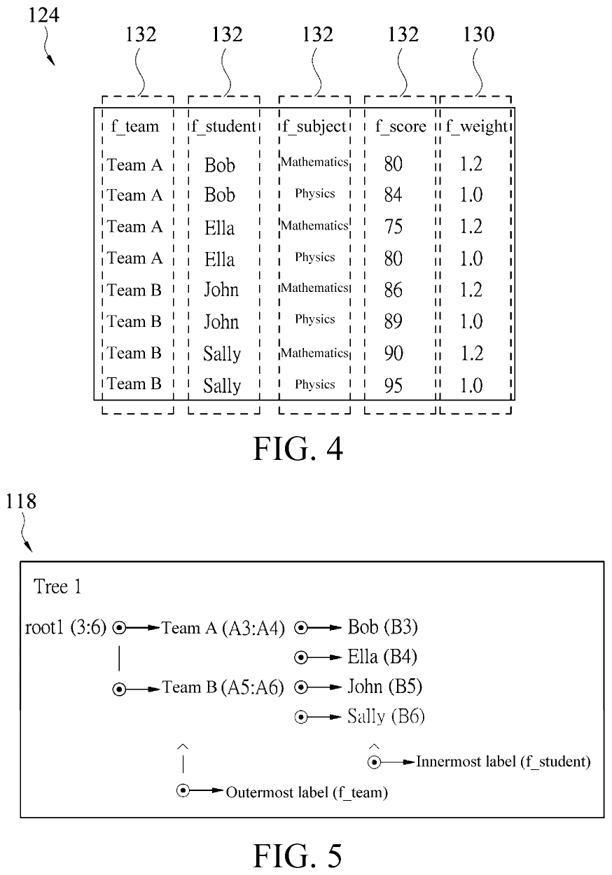

Refer to FIG. 1, FIG. 2, FIG. 3, and FIG. 4. FIG. 1 is a block diagram of an electronic device according to some embodiments of the present invention. FIG. 2 is a flowchart of a processing module executing a program instruction according to some embodiments of the present invention. FIG. 3 is a schematic diagram of a data sheet according to some embodiments of the present invention. FIG. 4 is a schematic diagram of a database data model according to some embodiments of the present invention. As shown in FIG. 1 to FIG. 4, in some embodiments, an electronic device 10 includes a storage module 102 and a processing module 104. The storage module 102 is configured to store at least one program instruction 106. The processing module 104 is coupled to the storage module 102 and is configured to load the at least one program instruction 106 to perform the following steps. Parse a plurality of cells 112 in an analysis region 110 of a data sheet 108 to identify each cell 112 as one of at least one formula cell 114 and at least one non-formula cell 116 (step S1 in FIG. 2). Classify, according to a formula expression of the at least one formula cell 114, the at least one formula cell 114 to at least one formula group (step S2 in FIG. 2). Selectively establish a side label category tree 118, a top label category tree 120, and a master category tree 122 according to the at least one formula group (step S3 in FIG. 2). Establish a database data model 124 according to the side label category tree 118, the top label category tree 120, and the master category tree 122 (step S4 in FIG. 2). Convert, according to the side label category tree 118, the top label category tree 120, and the master category tree 122, formula expressions into a structure reference form (step S5 in FIG. 2).

It should be noted that in order to clearly describe the specified cell 112 below, the specified cell 112 is represented by column indexes and row indexes of the specified cell 112. For example, a cell 112 that is located in column B and row 2 is represented as cell “B2”, a cell 112 that is located in column C and row 4 is represented as cell “C4”, and so on. In addition, for a range of a plurality of cells specified in a continuous row and/or in a continuous column, column indexes and row indexes within the range of the top left cell 112 and the bottom right cell 112 of the continuous cells 112 are taken and are separated by colons for representation. For example, cells (C3:C6) represent the continuous cells 112 within a range that is from row 3 to row 6 and that is under column C, that is, a cell C3, a cell C4, a cell C5, and a cell C6. For another example, cells (C3:D3) represent the continuous cells 112 that are in row 3 and that correspond to column C to column D, that is, a cell C3 and a cell D3. For another example, cells (C3:D4) represent a range that is from column C to column D and that is from row 3 to row 4, that is, a cell C3, a cell C4, a cell D3, and a cell D4. In addition, for a plurality of specified and non-consecutive cells 112, the cells 112 are separated by commas for representation. For example, cells (A3, A5) represent a cell A3 and a cell A5. If a specific cell 112 is not specified, a cell 112 is used for representation. In the following description, the formula cell 114 and the non-formula cell 116 are also referred to in a same manner.

The electronic device 10 may be, for example, a computer device, a handheld electronic device, a server, or a cloud server that can execute the program instruction 106. In some embodiments, the electronic device 10 can receive input from a user that includes operation information, so that the processing module 104 can execute a corresponding program instruction 106 according to the operation information. In some embodiments, the electronic device 10 further includes an input module 126 and a display module 128. The input module 126 can generate the operation information according to an operation of a user. The input module 126 may be, for example, a keyboard, a mouse, or a touch panel. The display module 128 can display a data sheet 108 and an editing process of the data sheet 108. The display module 128 may be, for example, a screen or a touch screen.

The storage module 102 may be, for example, a non-transitory computer-readable storage medium. The non-transitory computer-readable storage medium may be a hard disk drive (HDD), a solid-state drive (SSD), a read-only memory (ROM), or a compact disc read only memory (CD ROM). The storage module 102 can store the foregoing data sheet 108 and the database data model 124. The storage module 102 may be alternatively built in a cloud server. The electronic device 10 can be connected to the cloud server through an Internet to store the data sheet 108 and the database data model 124 in a cloud space or a web page space.

The processing module 104 may be, for example, a central processing unit (CPU) or a processor of an ARM instruction set. The processing module 104 can read and execute the program instruction 106, edit the data sheet 108 according to the operation information, and display the data sheet 108 on the display module 128. In some embodiments, the processing module 104 may rewrite the formula expression from an A1 notation to an R1C1 notation and use the same R1C1 notation for grouping.

The program instruction 106 can be stored in the storage module 102 in advance, so that after the processing module 104 loads the program instruction 106, the processing module 104 converts the data sheet 108 into the database data model 124 according to the execution steps of the program instruction 106, and transforms each formula expression into a structure reference form.

As shown in FIG. 3, the data sheet 108 may be, for example, a spreadsheet. The spreadsheet may be, for example, a file with an extension name of XLSX or XLS, or any spreadsheet that the user can intuitively understand the content and with file format that can be edited by the user through the electronic device 10. There are a plurality of cells 112 in the data sheet 108, and according to the content of each cell 112 (such as a function, a number, or a text), each cell 112 with content can be distinguished as a formula cell 114 or a non-formula cell 116. The formula cell 114 indicates that the cell 112 includes a formula expression (the formula expression may refer to a function of the spreadsheet). For example, in FIG. 3, a formula expression in a formula cell C7 is “=AVERAGE(C3:C6)”, a formula expression in a formula cell D7 is “=AVERAGE(D3:D6)”, and there are other formula cells (E3:E6) and formula cells (F3:F6). A range of the referenced cell 112 in the function is a calculation range of the function. For example, the calculation range of the AVERAGE function in the formula cell C7 is (C3:C6). At least one non-formula cell 116 indicates that the cell 112 only records text, numbers, or a combination of text and numbers, and does not include any function, for example, cells (A3, A5, A7, A8), cells (B2:B6), cells (C1:C6), cells (D1:D6), a cell E1, and a cell F1 in FIG. 3. In some embodiments, the data sheet 108 includes one or more analysis regions 110. The analysis region 110 may be selected by the user by operating the input module 126, or may be preset to an entire range of the data sheet 108.

A formula group refers to a group of a plurality of formula cells 114 with similar formula expressions. For example, in the data sheet 108, the functions used in formula cells (E3:E6) are the same and are “=SUMO”, and the calculation ranges in the functions are similar, and a range of the reference cell has the same offset relative to the corresponding formula cell 114, so the processing module 104 classifies the formula cells (E3:E6) into the same formula group (described in detail later).

The side label category tree 118 refers to a tree-type data structure established by the processing module 104 according to at least one side label. The top label category tree 120 refers to a tree-type data structure established by the processing module 104 according to at least one top label. The master category tree 122 refers to a tree-type data structure obtained by the processing module 104 through merging the side label category tree 118 and the top label category tree 120 (described in detail later).

As shown in FIG. 4, the database data model 124 may be, for example, a file of an operational data store (ODS). The database data model 124 can help the processing module 104 perform more efficient numerical analysis.

In some embodiments, step S2 further includes: When the functions of the formula expressions of the formula cells 114 are the same and the cells 112 referenced by the function have a same offset relative to their corresponding formula cell 114, classify similar formula cells 114 into a same formula group. As shown in FIG. 3, taking formula cells (E3:E6) as examples, a function of a formula cell E3 is “=SUM(C3:D3)”, a function of a formula cell E4 is “=SUM(C4: D4)”, a function of a formula cell E5 is “=SUM(C5:D5)”, and a function of a formula cell E6 is “=SUM(C6:D6)”. The processing module 104 can determine that the functions of the formula cells (E3:E6) are all “=SUMO”. In addition, the column offsets of the cell 112 referenced in the functions of the formula cells (E3:E6) relative to the corresponding formula cells (E3:E6) are all −2 and the row offsets are all 0. Therefore, the formula cells (E3:E6) are classified in the same formula group. The formula cell E3 is used as an example to illustrate the calculation method of the offset. From the formula cell E3, the cells 112 referenced by the functions are within a range from a cell C3 to a cell D3. One of the cells 112 in the reference cell range is used as a reference point to calculate the offset relative to the formula cell E3. For example, in this specification, the top left cell 112 of the reference range (the cell C3 in this case) is used as a reference point to calculate the offset relative to the formula cell E3. Therefore, by calculating the offset of the cell C3 relative to the formula cell E3, the column offset can be calculated to be −2 (that is 3-5) and the row offset is 0 (that is 3-3).

Due to general tabulation conventions, formulas used to calculate subtotals or grand totals are often set in a row below or in a column on the right. Therefore, there is a formula group whose type is a single-row formula group, and there is another formula group whose type is a single-column formula group. In some embodiments, step S2 further includes the following steps. Define, when all the formula cells 114 in the formula group are located in a same row, the formula group as a single-row formula group. Define, when all the formula cells 114 in the formula group are located in a same column, the formula group as a single-column formula group. Define another formula group that does not belong to the single-row formula group nor the single-column formula group as a single-cell formula group. For example, the formula group (E3:E6) is located in the same column and the formula cells (E3:E6) have the same function, and the column offsets are all “−2”, and the row offsets are all “0”, so the formula group (E3:E6) is defined as a single-column formula group. For another example, the formula group (C7:D7) is located in the same row and the formula cells (C7:D7) have the same function, and the column offsets are all “0”, and the row offsets are all “4”, so the formula group (C7:D7) is defined as a single-row formula group. In addition, the function of the formula cell E8 is “=MAX(C3:D6)”, and there are no other formula cells 114 similar to the formula cell E8 in the analysis region 110. Therefore, the formula cell E8 is classified into a single-cell formula group.

In some embodiments, step S2 further includes the following steps. Analyze the function of the formula cells 114 to establish a reference relationship; and retrieve table values of corresponding non-formula cells 116 according to the reference relationship. Specifically, the processing module 104 analyzes the function of the formula cell 114 to obtain a reference relationship of all formula cells 114. The reference relationship refers to a relationship between the analyzed formula cell 114 and the cell 112 referenced in the function. For example, the function of the formula cell E3 is “=SUM(C3:D3)”, and the function “=SUMO” refers to cells (C3:D3), so that there is a reference relationship between the formula cell E3 and the cells (C3:D3). This reference relationship can be represented, for example, as E3->(C3:D3), which indicates that the formula cell E3 refers to cells (C3:D3). Then, after the foregoing reference relationship is established, the processing module 104 can find the cells 112 referenced by all the formula cells 114 according to the reference relationship, so as to retrieve table values of the referenced cells 112. Following the foregoing example, the processing module 104 retrieves the corresponding table values 80 (the cell C3) and 84 (the cell D3) according to the reference relationship. For another example, the function of the formula cell F3 is “SUMPRODUCT(C3:D3, $C$2:$D$2)”, and the function “=SUMPRODUCT( )” refers to cells (C3:D3) and cells (C2:D2), so that the formula cell F3 establishes a reference relationship with the cells (C3:D3) and the cells (C2:D2) respectively. This reference relationship can be represented, for example, as F3->(C3:D3, C2:D2). Then, the processing module 104 retrieves the corresponding table values 1.2 (the cell C2), 1.0 (the cell D2), 80 (the cell C3), and 84 (the cell D3) according to the reference relationship. For another example, the function of the formula cell C7 is “=AVERAGE(C3:C6)”, and the function “=AVERAGE( )” refers to cells (C3:C6), so that there is a reference relationship between the formula cell C7 and the cells (C3:C6). The processing module 104 retrieves the corresponding table values 80 (the cell C3), 75 (the cell C4), 86 (the cell C5), and 90 (the cell C6) according to the reference relationship.

In some embodiments, step S3 further includes the following steps. Classify, according to a function of the formula expressions, referenced cells 112 into at least one data group; and selectively establish the side label category tree 118, the top label category tree 120, and the master category tree 122 according to the at least one data group. The data group can be at least one aggregable data group or at least one non-aggregable data group. Specifically, the processing module 104 can traverse the cells 112 referenced in the function through the function of the formula expression, and classify each referenced cell 112 into the at least one aggregable data group or the at least one non-aggregable data group (described in detail below). Through the boundaries of these data groups, the positions of the cells 112 such as side labels and top labels in the data sheet 108 can be further identified later (described in detail later). Thereby, the processing module 104 can establish the side label category tree 118, the top label category tree 120, and the master category tree 122.

In some embodiments, when the function is one of an addition function (such as “=(C3+D3)”) and a subtraction function (such as “=(C3−D3)”), correspondingly referenced cells 112 are classified into the at least one aggregable data group. In some embodiments, when the function is an aggregate function, correspondingly referenced cells 112 are classified into the at least one aggregable data group. The aggregate function may be, for example, “=SUM( )”, “=COUNT( )”, “=AVERAGE( )”, “=MAX( )”, “=MIN( )”, “=STDDEV( )”, “=STDDEVP( )”, “=VAR( )”, “=VARP( )”, or “=DISTINCTCOUNT( )”.

In some embodiments, when the function is one of a multiplication function (such as “=(C3*D3)”) and a division function (such as “=(C3/D3)”), correspondingly referenced formula cells 114 are classified into the at least one non-aggregable data group.

In some embodiments, when the function is a non-aggregate function (such as “SUMPRODUCT( )”), correspondingly referenced cells 112 are classified into the at least one non-aggregable data group. In a non-aggregate function, the data groups referenced by the function are not aggregated into a single data group. For example, the function of the cell F3 is “=SUMPRODUCT(C3:D3,$C$2:$D$2)”. The data group “C3:D3” and the data group “C2:D2” referenced by the function belong to different groups.

Further, if the at least one aggregable data group intersects with other data groups (that is, has at least one overlapping cell 112), the intersecting data groups can be merged into at least one aggregable data group. For example, the function of the formula cell E8 is “=MAX(C3:D6)”, and the function of the formula cell E3 is “=SUM(C3:D3)”, where the data group “C3:D6” referenced by the formula cell E8 intersects with the data group “C3:D3” at the position of the cell C3 and the cell D3. Therefore, the processing module 104 merges the data group “C3:D6” and the data group “C3:D3” into at least one aggregable data group. Similarly, the data group composed of the cells 112 referenced by the formula cells (C7:D7) and the formula cells (E3:E6) are also merged with the data group “C3:D6” into at least one aggregable data group. In addition, the data group “C2:C2” in the foregoing non-aggregable data group does not intersect with the data group “C3:D6”, so the data group “C3:D6” and the data group “C2:D2” are eventually obtained.

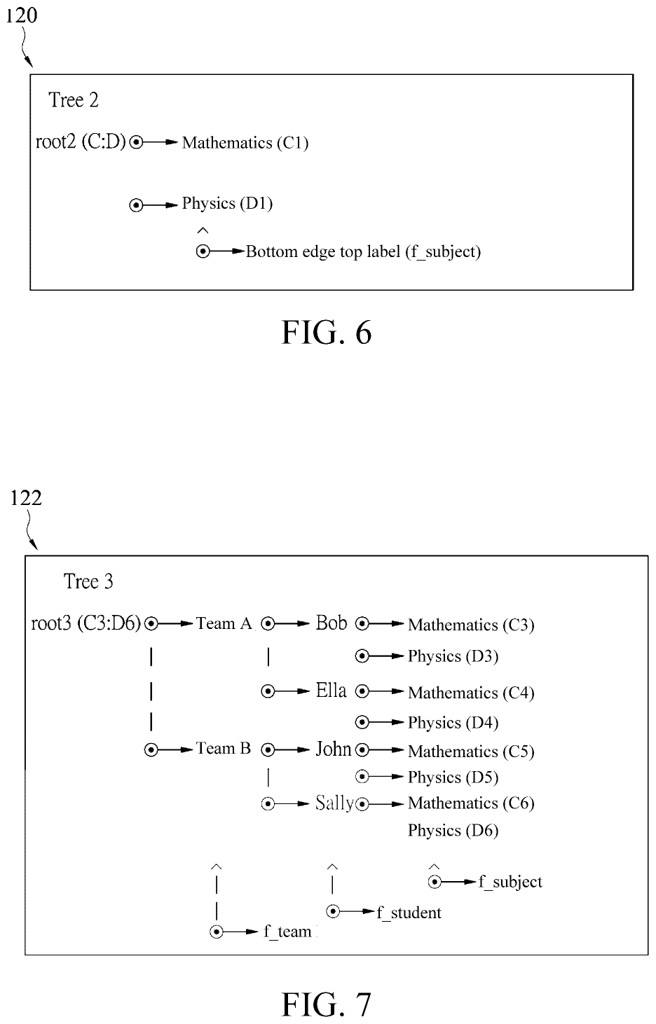

Next, the cells 112 surrounding the data group are scanned to find the side labels and the top labels, thereby establishing the side label category tree 118, the top label category tree 120, and the master category tree 122. Refer to FIG. 5, FIG. 6, and FIG. 7. FIG. 5 is a schematic diagram of a side label category tree according to some embodiments of the present invention. FIG. 6 is a schematic diagram of a top label category tree according to some embodiments of the present invention. FIG. 7 is a schematic diagram of a master category tree according to some embodiments of the present invention. In some embodiments, step S3 further includes the following steps. Establish, according to side labels of the analysis region 110, the side label category tree 118; establish, according to top labels of the analysis region 110, the top label category tree 120; and merge the side label category tree 118 and the top label category tree 120 into the master category tree 122.

As shown in FIG. 5, the processing module 104 can identify a scanned label region from the formula expression of a formula group, so as to establish the tree-type data structure of the formula group according to the scanned labels. The process of establishing the tree-type data structure of the side label category tree 118 is described first. Take the formula group (E3:E6) that refers to the data group “C3:D6” as an example. The processing module 104 can identify, according to the formula expression, that the range of the cells 112 referenced by the formula group (E3:E6) is the cells (C3:D6). In order to find the side labels, according to tabulation conventions, generally the side labels are in a left region of the same row as the cells 112 filled with values. Therefore, the processing module 104 scans the labels outward column by column in sequence from the cells 112 that are in the left region of the range of the referenced cells 112 and that overlap with the row range of the referenced cells 112 (the 3^{rd} row to the 6^{th} row). Specifically, first the labels “Bob”, “Ella”, “John”, and “Sally” are scanned from the first column (column B) on the left of the referenced cell range. These labels are used as a tree node of the side label category tree 118 respectively. Then, the labels “Team A” and “Team B” are scanned in the next column (column A). These labels are also respectively used as a tree node of the side label category tree 118 and are a parent node of the label in the previous column. The rows in which the labels of two adjacent columns are located determine a parent-child connection relationship between nodes. For example, the label “Bob” is in the same row as the label “Team A”, so the label “Team A” is used as the parent node of the label “Bob”. The row in which the label “Ella” is located is below the row in which the label “Team A” is located, but above the row in which another label (that is, the label “Team B”) is located, so the label “Team A” is also used as the parent node of the label “Ella”. Similarly, the label “Team B” is used as the parent node of the label “John” and the label “Sally”. Through the foregoing method, the side label category tree 118 can be established.

In some embodiments, after the processing module 104 obtains the side label, the processing module 104 can specify or generate a corresponding label name according to the label contents. Alternatively, the user can change the specified or generated label name by operating the input module 126. Taking an example in which the processing module 104 generates the corresponding label name according to the label content, in the side label category tree 118, the label name of the innermost labels is “f_student” and the label name of the outermost labels is “f_team”. The processing module 104 can analyze the text of the data sheet 108 according to a natural language model to generate the corresponding label name respectively. For example, “Bob”, “Ella”, “John”, and “Sally” are names, “Mathematics” and “Physics” are subjects, “Total score” and “Weighted total score” are scores, and the processing module 104 can determine that the data sheet 108 is related to academic performance. Therefore, the label name of the innermost labels is defined as “f_student”, and the label name of the outermost labels is defined as “f_team”.

As shown in FIG. 6, the establishment process of the top label category tree 120 is described. Taking the formula group (E3:E6) that refers to the data group “C3:D6” as an example, the processing module 104 can identify, according to the formula expression, that the range of the cells referenced by the formula group (E3:E6) is the cells (C3:D6). In order to find the top labels, according to tabulation conventions, generally the top labels are in a top region of the same column as the cells 112 filled with values. Therefore, the processing module 104 scans the labels upward row by row in sequence from the cells 112 that are in the top region of the referenced cell range and that overlap with the column range of the referenced cells 112 (column C to column D). Specifically, the labels “Mathematics” and “Physics” are scanned from the top row (row 1) of the reference cell range, and these labels are used as a tree node of the top label category tree 120 respectively. In this example, only one level of top labels are scanned. If in other embodiments, top labels of other levels can be scanned, a multi-level top label category tree 120 can be established. In some embodiments, after the processing module 104 obtains the top labels, the processing module 104 can specify or generate a corresponding label name according to the label contents of the top labels. Alternatively, the user can change the specified or generated label name by operating the input module 126. For example, the top labels are “Mathematics” and “Physics”, and the corresponding label name may be related to subjects, so the label name of the top labels is defined as “f_subject”.

FIG. 7 shows the master category tree 122, which is formed by merging the foregoing side label category tree 118 and the top label category tree 120. Specifically, the processing module 104 copies the side label category tree 118 to establish the master category tree 122, and copies the top label category tree 120 and joins it to each leaf node of the established master category tree 122 (that is, the leaf nodes are used as the root node of the copied top label category tree 120). In this example, the label “Bob”, the label “Ella”, the label “John”, and the label “Sally” are respectively root nodes, and then are connected with the top labels “Mathematics” and “Physics”. The master category tree 122 is given a root node that connects the label “Team A” and the label “Team B”. The root node of the master category tree 122 is marked as (C3:D6), which represents the row coverage of the side label category tree 118 and the column coverage of the top label category tree 120 to illustrate that this master category tree 122 represents the side labels and top labels that are associated with the cells (C3:D6) where the column coverage intersects with the row coverage. In addition, each leaf node of the master category tree 122 is marked according to row indexes of the side label and column indexes of the top label corresponding to the leaf node. For example, “Mathematics” of “Bob” is marked as (C3), and “Physics” of “Bob” is marked as (D3). In some embodiments, the processing module 104 imports the outermost labels “f_team”, the innermost labels “f_student”, and the bottommost top labels “f_subject” into the master category tree 122 respectively.

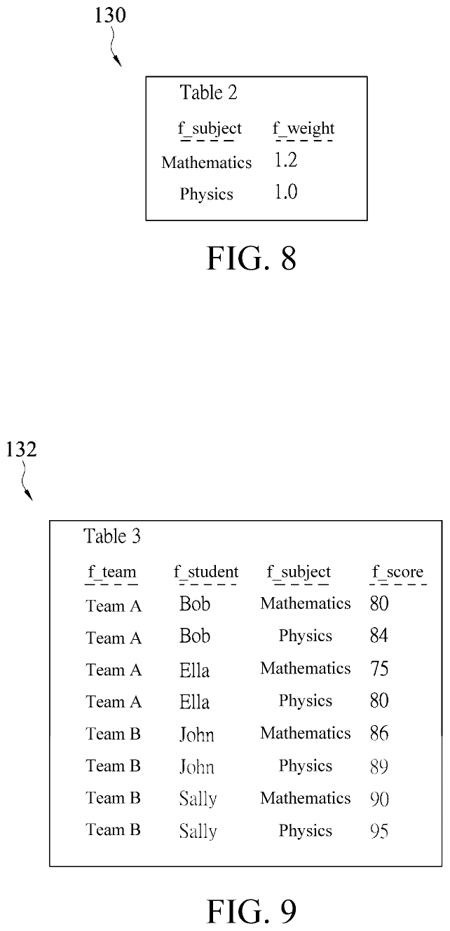

Referring to FIG. 8, FIG. 8 is a schematic diagram of a first data model according to some embodiments of the present invention. In some embodiments, the at least one non-aggregable data group includes a single-row non-aggregable data group. A first data model 130 is established at an intersection of the single-row non-aggregable data group and the top label category tree 120. The first data model 130 includes a first category field and a first value field. Specifically, when any single-row non-aggregable data group only intersects with the column indexes (described in detail later) of the tree node (a top label) of the top label category tree 120, the processing module 104 establishes a first data model 130 corresponding to the single-row non-aggregable data group. The establishing manner of the first data model 130 is described below. For example, the column in which the single-row non-aggregable data group (C2:D2) is located only intersects with the column in which the tree nodes (the cell C1 and the cell D1) of the top label category tree 120 are located. The processing module 104 establishes a first category field in the first data model 130 according to each level of the top label category tree 120. Same as the foregoing example, according to the top labels of the top label category tree 120 shown in FIG. 6, the processing module 104 sets the first category field to “f_subject”. When the column in which the tree node (a top label) of the top label category tree 120 is located intersects with any single-row non-aggregable data group on the column, the processing module 104 establishes a first value field according to the single-row non-aggregable data group. Same as the foregoing example, the first value field is “f weight”. The processing module 104 traverses each path from the root node to the leaf node of the top label category tree 120, and records the label content of each node on the path in the first category field. The processing module 104 records the contents (in this example, data 1.2 of the cell C2 and 1.0 of the cell D2) of the cell 112 that is in the single-row non-aggregable data group and corresponds to the column indexes in which the tree node of the top label category tree 120 is located in the corresponding first value field (“f weight”).

Intersection may refer to indexes in the same column/row. The foregoing “A first data model 130 is established at an intersection of the single-row non-aggregable data group and the top label category tree 120.” may mean that the single-row non-aggregable data group (in a horizontal direction of the analysis data sheet 108) and the top labels (in a horizontal direction of the analysis data sheet 108) have the same column indexes in the data sheet 108, for example, in FIG. 6, weights of the single-row non-aggregable data group (C2:D2), 1.2 (C2) and 1.0 (D2), and the top labels, “Mathematics” (C1) and “Physics” (D1), have the intersection in the column indexes. The intersection of the weight 1.2 and the top label “Mathematics” is in column C, and the intersection of the weight 1.0 and the top label “Physics” is in column D, so as to establish the first data model 130 in FIG. 8.

In some embodiments, the at least one non-aggregable data group includes a single-column non-aggregable data group. A second data model is established at an intersection of the single-column non-aggregable data group and the side label category tree 118, and the second data model includes a second category field and a second value field. Specifically, non-aggregable data groups in the same column may be defined as a single-column non-aggregable data group. When any single-column non-aggregable data group only intersects with the row indexes (described in detail later) of the tree node (a side label) of the side label category tree 118, the processing module 104 establishes a second data model corresponding to the single-column non-aggregable data group. The establishing manner of the second data model is described below. For example, any single-column non-aggregable data group (not shown in the figure) only intersects with the row in which the tree node of the side label category tree 118 is located. The processing module 104 establishes a second category field in the second data model according to each level of the side label category tree 118. When the row in which the tree node (a side label) of the side label category tree 118 is located intersects with any single-column non-aggregable data group on the row, the processing module 104 establishes a second value field according to the single-column non-aggregable data group. The processing module 104 traverses each path from the root node to the leaf node of the side label category tree 118, and records the label content of each node on the path in the second category field. The processing module 104 records the contents of the cell 112 that is in the single-column non-aggregable data group and corresponds to the row indexes in which the tree node of the side label category tree 118 is located in the corresponding second value field. It should be noted that in the data sheet 108 in FIG. 3, since there is no single-column non-aggregable data group that intersects the tree node of the side label category tree 118 on the row, the processing module 104 does not establish the second data model corresponding to the side label category tree 118.

Referring to FIG. 9, FIG. 9 is a schematic diagram of a third data model according to some embodiments of the present invention. In some embodiments, a third data model 132 is established at an intersection of the at least one aggregable data group and the master category tree 122. The third data model 132 includes a third category field and a third value field. In some embodiments, the processing module 104 establishes a third category field in the third data model 132 according to each level of the master category tree 122. The processing module 104 traverses each path from the root node to the leaf node of the side label category tree 118 and traverses each path from the root node to the leaf node of the top label category tree 120. When each path of the side label category tree 118 and each path of the top label category tree 120 intersect on a row and a column respectively, the processing module 104 establishes the third value field. The processing module 104 traverses each path from the root node to the leaf node of the master category tree 122, and records the label content of each node on the path in the third category field. In some embodiments, the processing module 104 records the contents of the cell 112 that is in the at least one aggregable data group and corresponds to the row indexes and the column indexes in which the tree nodes of the side label category tree 118 and the top label category tree 120 are located in the corresponding third value field.

For example, the data group (C3:D6) intersects with the row indexes and the column indexes of the tree node of the master category tree 122 on the row and the column respectively. Therefore, the processing module 104 establishes the third data model 132 corresponding to the data group (C3:D6). The establishing manner of the third data model 132 is described below. First, third category fields corresponding to three-level tree nodes of the master category tree 122 are established, which are “f_team”, “f_student”, and “f_subject” respectively. In addition, a third value field (“f_score”) is established corresponding to the aggregable data group (C3:D6). In addition, the content in the third data model 132 is filled in according to the master category tree 122 and the aggregable data group (C3:D6). There are eight paths intersecting with the tree nodes of the master category tree 122. The first path is “Team A”, “Bob”, and “Mathematics” (C3). The second path is “Team A”, “Bob”, and “Physics” (D3). The third path is “Team A”, “Ella”, and “Mathematics” (C4). The fourth path is “Team A”, “Ella”, and “Physics” (D4). The fifth path is “Team B”, “John”, and “Mathematics” (C5). The sixth path is “Team B”, “John”, and “Physics” (D5). The seventh path is “Team B”, “Sally”, and “Mathematics” (C6). The eighth path is “Team B”, “Sally”, and “Physics” (D6). The processing module 104 records the contents of the corresponding cells 112 to corresponding third category fields. Taking “Mathematics” score of “Bob” (the cell C3) as an example, the path is “Team A” (the cell A3), “Bob” (the cell B3), and “Mathematics” (the cell C1). The processing module 104 can obtain data of the cell A3 and the cell B3 (“Team A” and “Bob”) from the path of the tree node of the master category tree 122 (taking the cell C3 as an example) that intersects with row 3, and can obtain data of the cell C1 (“Mathematics”) from the path of the tree node of the master category tree 122 (taking the cell C3 as an example) that intersects with column C. In addition, the processing module 104 records the data “80” of the cell C3 in the corresponding third value field (“f_score”). Other cells 112 that intersect with the tree nodes of the master category tree 122 on columns or rows are also recorded in the corresponding third value field, and so on. Details are not described herein again. The processing module 104 completes recording all the cells 112 that intersect with the tree nodes of the master category tree 122 on columns and rows in the third value field, that is, the third data model 132 in FIG. 9 is completed.

In some embodiments, step S4 further includes the following step. Merge the first data model 130, the second data model, and the third data model 132 into the database data model 124. Specifically, the processing module 104 can merge the first data model 130, the second data model, and the third data model 132 into the database data model 124 through a left join operation. It should be noted that since the processing module 104 does not establish the second data model, the database data model 124 in FIG. 4 is obtained by merging the first data model 130 and the third data model 132.

In some embodiments, step S5 further includes the following steps. For the formula group defined under the single-row formula group: searching for each cell 112 referenced by the single-row formula group; searching for a row range of the referenced cells 112; traversing the side label category tree 118 to find row indexes covering the row range; and forming the structure reference form according to the row indexes. Specifically, the processing module 104 searches for a referenced cell 112 or a region (the region refers to a range composed of a plurality of cells 112) according to the formula expression of each single-row formula group to find an associated data group and an associated value field. The processing module 104 searches for the referenced cell 112 or a row range of the region. The processing module 104 traverses the side label category tree 118 from the root node to the leaf node to find a first node that covers the row range (referred to as the first row tree node). The processing module 104 uses the first row tree node of the side label category tree 118 as row indexes to search for the associated value field to form a structure reference. The processing module 104 replaces the cell 112 or the region with the structure reference. For example, the processing module 104 can rewrite the formula expression of the single-row formula group from the A1 notation to a structure reference notation (the structure reference includes a category field, a value field, a category item, and a table name). In some embodiments, if the first row tree node is the root node, it means that this node covers all rows of the data group, and then the row indexes can be ignored, making the converted formula expression more concise.

For example, the function of the single-row formula group is “=AVERAGE(C3:C6)”. The associated value field of the data group of the referenced cells (C3:C6) is “f_score”. The corresponding row range of the data sheet 108 is row 3 to row 6. The nodes of the side label category tree 118 are traversed and the root node whose row range covers the 3^{rd} row to the 6^{th} row, that is, all rows of “f_score”, are identified as the mapping node. The function is converted to “=AVERAGE([f_score][*])” and simplified to “=AVERAGE([f_score]”.

In some embodiments, step S5 further includes the following steps. For the formula group defined under the single-column formula group: searching for each cell 112 referenced by the single-column formula group; searching for a column range of referenced cells 112; traversing the top label category tree 120 to find column indexes covering the column range; and forming the structure reference form according to the column indexes. Specifically, the processing module 104 searches for a referenced cell 112 or a region according to the formula expression of each single-column formula group to find an associated data group and an associated value field. The processing module 104 searches for the referenced cell 112 or a column range of the region. The processing module 104 traverses the top label category tree 120 from the root node to the leaf node to find a first node that covers the column range (referred to as the first column tree node). The processing module 104 uses the first column tree node of the top label category tree 120 as column indexes to search for the associated value field to form a structure reference. The processing module 104 replaces the cell 112 or the region with the structure reference. For example, the processing module 104 can rewrite the formula expression of the single-column formula group from the A1 notation to a structure reference notation (the structure reference includes a category field, a value field, a category item, and a table name). In some embodiments, if the first column tree node is the root node, it means that this node covers all columns of the data group, and then the column indexes can be ignored, making the converted formula expression more concise.

For example, the function of the single-column formula group is “=SUM(C3:D3)”. The associated value field of the data group of the referenced cells (C3:D3) is “f_score”. The corresponding column range of the data sheet 108 is column C to column D. The nodes of the top label category tree 120 are traversed and the root node whose column range covers column C to column D, that is, all columns of “f_score”, are identified as the mapping node. The function is converted to “=SUM([f_score][*])” and simplified to “=SUM([f_score])”.

In some embodiments, step S5 further includes the following steps. For the formula group under the single-cell formula group: searching for each cell 112 referenced by the single-cell formula group; searching for a column range and a row range of the referenced cell 112; traversing the side label category tree 118 to find row indexes covering the row range; traversing the top label category tree 120 to find column indexes covering the column range; and forming the structure reference form according to the column indexes and the row indexes. Specifically, the processing module 104 traverses the referenced cells 112 or regions according to the formula expression of each single-cell formula group to find an associated data group and an associated value field. The processing module 104 searches for the referenced cell 112 or a row range and a column range of the region. The processing module 104 traverses the side label category tree 118 from the root node to the leaf node to find a first node that covers the row range (referred to as the first row tree node), and traverses the top label category tree 120 from the root node to the leaf node to find a first node that covers the column range (referred to as the first column tree node). The processing module 104 uses the found first row tree node of the side label category tree 118 as row indexes and uses the found first column tree node of the top label category tree 120 as column indexes to form a structure reference. The processing module 104 replaces the cell 112 or the region with the structure reference. For example, the processing module 104 can rewrite the formula expression of the single-cell formula group from the A1 notation to a structure reference notation (the structure reference includes a category field, a value field, a category item, and a table name). In some embodiments, if the first row tree node is the root node, it means that this node covers all rows of the side label category tree 118, and then the row indexes can be ignored, making the converted formula expression more concise. If the first column tree node is the root node, it means that this node covers all columns of the top label category tree 120, and then the column indexes can be ignored, making the converted formula expression more concise.

In conclusion, the present invention provides an electronic device 10 and a non-transitory computer-readable storage medium. The processing module 104 can automatically convert a data sheet 108 into a database data model for the electronic device 10 to perform subsequent analysis and processing operations, and identify a cell 112 in the data sheet 108 as one of a formula cell 114 or a non-formula cell 116, to accurately determine a side label, a top label, and a table value, so that the established database data model 124 can improve accuracy of importing values to different fields. In addition, the processing module 104 converts each formula expression into a structure reference form, which is easier to understand the semantics of an expression than an expression in A1 notation recorded in an original data sheet 108. That is, when the processing module 104 parses a formula expression in the structure reference form, the meaning of the formula expression can be understood from a structure of the formula.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device, comprising:
a storage module, configured to store at least one program instruction; and
a processing module, coupled to the storage module and configured to load the at least one program instruction to perform the following steps:
parsing a plurality of cells in an analysis region of a data sheet to identify each cell as one of at least one formula cell and at least one non-formula cell;
classifying, according to a formula expression of the at least one formula cell, the at least one formula cell to at least one formula group;
selectively establishing a side label category tree, a top label category tree, and a master category tree according to the at least one formula group;
establishing a database data model according to the side label category tree, the top label category tree, and the master category tree; and
converting, according to the side label category tree, the top label category tree, and the master category tree, formula expressions into a structure reference form.

2. The electronic device according to claim 1, wherein a step of selectively establishing the side label category tree, the top label category tree, and the master category tree according to the at least one formula group further comprises:
classifying, according to a function of the formula expressions, referenced cells into at least one data group; and
selectively establishing the side label category tree, the top label category tree, and the master category tree according to the at least one data group, wherein
the at least one data group comprises at least one aggregable data group and at least one non-aggregable data group.

3. The electronic device according to claim 2, wherein when at least one aggregable data group intersects with another data group, the intersecting data groups are merged into the at least one aggregable data group.

4. The electronic device according to claim 3, wherein when the function is one of an addition function and a subtraction function, correspondingly referenced cells are classified into the at least one aggregable data group.

5. The electronic device according to claim 3, wherein when the function is an aggregate function, correspondingly referenced cells are classified into the at least one aggregable data group.

6. The electronic device according to claim 3, wherein when the function is one of a multiplication function and a division function, correspondingly referenced cells are classified into the at least one non-aggregable data group.

7. The electronic device according to claim 3, wherein when the function is a non-aggregate function, correspondingly referenced cells are classified into the at least one non-aggregable data group.

8. The electronic device according to claim 3, wherein the step of selectively establishing the side label category tree, the top label category tree, and the master category tree according to the formula group further comprises:
establishing the side label category tree according to at least one side label of the analysis region;
establishing the top label category tree according to at least one top label of the analysis region; and
merging the side label category tree and the top label category tree into the master category tree.

9. The electronic device according to claim 8, wherein the at least one non-aggregable data group comprises a single-row non-aggregable data group; and a first data model is established at an intersection of the single-row non-aggregable data group and the top label category tree, and the first data model comprises a first category field and a first value field.

10. The electronic device according to claim 9, wherein the at least one non-aggregable data group comprises a single-column non-aggregable data group; and a second data model is established at an intersection of the single-column non-aggregable data group and the side label category tree, and the second data model comprises a second category field and a second value field.

11. The electronic device according to claim 10, wherein a third data model is established at an intersection of the at least one aggregable data group and the master category tree, and the third data model comprises a third category field and a third value field.

12. The electronic device according to claim 11, wherein a step of establishing the database data model according to the side label category tree, the top label category tree, and the master category tree further comprises: merging the first data model, the second data model, and the third data model into the database data model.

13. The electronic device according to claim 2, wherein a step of classifying, according to the formula expression of the at least one formula cell, the at least one formula cell to the at least one formula group further comprises: when the functions of the formula expressions are the same and the cells referenced by the function have a same offset relative to a corresponding formula cell, classifying similar formula cells into a same formula group.

14. The electronic device according to claim 13, wherein a step of classifying, according to the formula expression of the at least one formula cell, the at least one formula cell to the at least one formula group further comprises:
defining, when all the formula cells in the formula group are located in a same row, the formula group as a single-row formula group;
defining, when all the formula cells in the formula group are located in a same column, the formula group as a single-column formula group; and
defining another formula group that does not belong to the single-row formula group nor the single-column formula group as a single-cell formula group.

15. The electronic device according to claim 14, wherein a step of converting, according to the side label category tree, the top label category tree, and the master category tree, the formula expressions into the structure reference form further comprises:
for the formula group defined under the single-column formula group:
searching for each cell referenced by the single-column formula group;
searching for a column range of referenced cells;
traversing the top label category tree to find column indexes covering the column range; and
forming the structure reference form according to the column indexes.

16. The electronic device according to claim 14, wherein a step of converting, according to the side label category tree, the top label category tree, and the master category tree, the formula expressions into the structure reference form further comprises:
for the formula group defined under the single-row formula group:
searching for each cell referenced by the single-row formula group;
searching for a row range of referenced cells;
traversing the side label category tree to find row indexes covering the row range; and
forming the structure reference form according to the row indexes.

17. The electronic device according to claim 14, wherein a step of converting, according to the side label category tree, the top label category tree, and the master category tree, the formula expressions into the structure reference form further comprises:
for the formula group defined under the single-cell formula group:
searching for each cell referenced by the single-cell formula group;
searching for a column range and a row range of referenced cells;
traversing the side label category tree to find row indexes covering the row range;
traversing the top label category tree to find column indexes covering the column range; and
forming the structure reference form according to the column indexes and the row indexes.

18. The electronic device according to claim 2, wherein a step of classifying, according to the formula expression of the at least one formula cell, the at least one formula cell to the at least one formula group further comprises:
analyzing the function of the formula cells to establish a reference relationship; and
retrieving table values of corresponding non-formula cells according to the reference relationship.

19. A non-transitory computer-readable storage medium, storing at least one program instruction, wherein after a computer loads and executes the at least one program instruction, the following steps are performed:
parsing a plurality of cells in an analysis region of a data sheet to identify each cell as one of at least one formula cell and at least one non-formula cell;
classifying, according to a formula expression of the at least one formula cell, the at least one formula cell to at least one formula group;
selectively establishing a side label category tree, a top label category tree, and a master category tree according to the at least one formula group;
establishing a database data model according to the side label category tree, the top label category tree, and the master category tree; and
converting, according to the side label category tree, the top label category tree, and the master category tree, formula expressions into a structure reference form.
